(19) United States
(12) Patent Application Publication
(10) Pub. No.: US 2016/0063652 A1
(43) Pub. Date: Mar. 3, 2016

(54) Infrared-Based Apparatus for Using Gestures to Place Food Orders and Method of Use

(71) Applicant: Jijesoft Co., Ltd., Suzhou (CN)

(72) Inventors: Zuojun Min, Suzhou Jiangsu (CN); Li Xinrui, Suzhou Jiangsu (CN)

(21) Appl. No.: 14/472,544

(22) Filed: Aug. 29, 2014

(51) Int. Cl. G06Q 50/12; G06F 3/01; G06F 3/03; G06Q 30/06

(52) U.S. Cl. CPC G06Q 50/12; G06Q 30/0633; G06Q 30/0641; G06F 3/017; G06F 3/0325

(57) ABSTRACT

An infrared-based gesture ordering apparatus with an infrared sensing unit comprising at least four infrared (IR) sensors, each with an independent infrared emitter and receiver, the sensing unit having an output, a processing unit that receives the IR sensing unit outputs, and a microprocessor that receives the processing unit output, where the microprocessor has an output that connects by USB or wireless to an order server that has a display device.

### FIELD

This invention involves a food-ordering apparatus, specifically an infrared-based apparatus that involves using gestures to place food orders.

### BACKGROUND

The overall workflow for current common kitchen ordering systems is that food orders are first entered using forms that are part of the ordering software; a controller then passes the forms to a display in the kitchen, and the kitchen prepares the food when it sees the orders. After food is sent out, the orderer changes the form state to show that the food has been served, and the kitchen can use a keyboard to enter the form's serial number and delete the form.

There are several problems with this arrangement. Commercial kitchens have extremely stringent health requirements, and this sort of touch input apparatus could pose a threat to health. Also, this process is time consuming. Further, the costs of manufacturing such an apparatus are currently far higher than for ordinary keyboards, because of the requirement for high durability in the face of extremely frequent use.

### SUMMARY

This disclosure relates to an infrared-based apparatus for using gestures to place food orders. It includes an infrared (IR) sensing unit that comprises at least four IR sensors, each with an independent infrared emitter and receiver. The IR sensing unit is connected to a processing unit. The processing unit output terminal is connected to a microprocessor input terminal, and the microprocessor output terminal is connected to a food-order server that has a display device installed. Thus, those placing orders can order different dishes, or confirm dishes have been served, using input gestures. There is no keyboard used in the entire process, as data input is accomplished without physical contact, ensuring food safety and health requirements are met. In addition, the actual operation of the apparatus is simple and easy to learn, its overall structure is uncomplicated, and it is easily installed and used in restaurant kitchens.

A purpose of this disclosure is to resolve the above issues with current technology by providing a non-contact input device (e.g., an infrared-based apparatus) that allows the user to use gestures to input commands into the food-order server, for example to place food orders. This is achieved by means of the following technical solutions.

An infrared-based gesture ordering apparatus includes an infrared sensing unit made up of at least four IR sensors, each with an independent infrared emitter and receiver. The sensing unit is connected to a processing unit. The processing unit output terminal connects to a microprocessor input terminal, and the microprocessor output terminal connects to an order server that has a display device installed. The order server can thus change an order status when it receives this output.

In addition, the aforementioned infrared-based gesture ordering apparatus includes the four IR sensors mentioned above, distributed more or less symmetrically in a vertical cross shape. The probes can be arranged in a clockwise sequence, such that the first sensing point is at 9 o'clock, the second at 12 o'clock, the third at 3 o'clock, and the fourth at 6 o'clock.

The aforementioned infrared-based gesture ordering apparatus also includes:
The IR sensors mentioned above, in protective tubing which acts to narrow the infrared sense area.
The processing unit mentioned above, including a processing assembly installed in a housing. The processing assembly input terminal connects to the signal output terminals from the IR sensors, and the processing assembly output terminal connects to the microprocessor input terminal.
The processing unit mentioned above also includes an amplifier module. A filter module connects to the output terminal of the amplifier module.
The housing mentioned above has a waterproof coating on its outside.
There is a wireless communications unit and USB communications port installed at the output terminal of the microprocessor. The wireless communications unit is a Bluetooth or wireless data communications device.
The display device mentioned above is an LED or liquid crystal display.

The main merits of these technical solutions are that, by means of data communications between the infrared sending unit, processing unit, and a separate server, those placing or serving food orders can use input gestures to enter orders for different dishes or confirm dishes have been served. There is no keyboard or other contact-based data input device used in the entire process, as data input is accomplished without physical contact, thus ensuring food safety and health requirements are met. In addition, the actual operation is simple and easy to learn, its overall structure is uncomplicated, and it is easily installed and used in restaurant kitchens.

### BRIEF DESCRIPTION OF THE DRAWINGS

The purpose, merits, and characteristics of this invention will be illustrated and explained below through a non-restrictive description of a preferred implementation.

FIG. 1 is a structural diagram of this infrared-based gesture ordering apparatus.

FIG. 2 is a process diagram depicting an interrupt service routine of the apparatus.

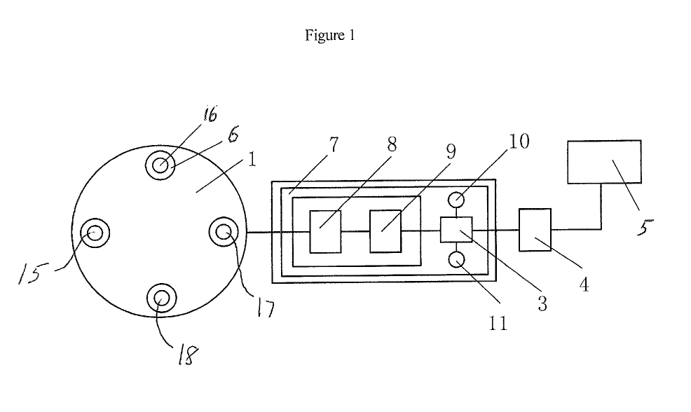

The following table maps the indicated numbers to aspects of FIG. 1.
1 Infrared Sensor Unit
15-18 Four IR sensors
3 Microprocessor
4 Order Server
5 Display Device
6 Protective Tubing
7 Box Housing
8 Amplifier Module
9 Filter Module
10 Wireless Communications Unit
11 USB Communications Port

### DETAILED DESCRIPTION

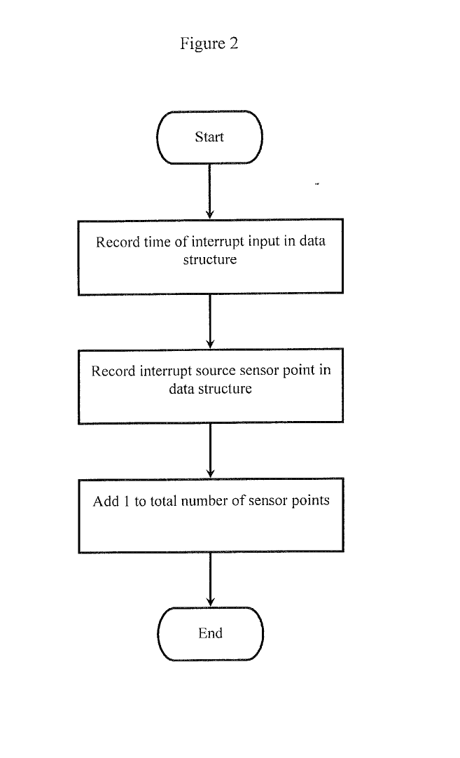

The subject gesture-based sensing apparatus and data input device operates without being touched. In one non-limiting example an infrared-based gesture ordering apparatus depicted in FIGS. 1 and 2 includes an infrared sensor unit 1, a unique aspect of which is that it is made up of at least four IR sensors 15, 16, 17 and 18. Each ER sensor has an independent infrared emitter and receiver. There is a processing unit connected to the sensor unit that receives the outputs of the sensors. At the same time, the processing unit output terminal connects to the microprocessor 3 input terminal. There is an order server 4 connected to the microprocessor output terminal. In addition, a display device 5 is installed on the order server 4, displaying symbols corresponding to the indicated gestures or changing to display a menu. The display device can be an LED or liquid crystal display.

In a preferred implementation of the apparatus, the four IR sensors are arranged in a more or less symmetrical vertical cross shape to achieve the best sensing of gestures: the first sensor point 15 is at 9 o'clock, the second 16 at 12 o'clock, the third 17 at 3 o'clock, and the fourth 18 at 6 o'clock. Because the detection angle of infrared detectors is comparatively broad, the IR sensors are encased in plastic protective tubing 6 so that they only detect gestures directly to the front; adding this facility can prevent the detection of irrelevant gestures by people in the background, thereby better controlling interference. Moreover, the first and third sensor points are about 15 centimeters apart, as are the second and fourth sensor points. The distance of this separation, determined based on the size of an adult hand, is to prevent interference between the sensor points and reduce the likelihood of mistaken detection.

In addition, the processing unit includes a housing 7 that contains several components. The processor facilitates gesture recognition and effective data collection. Housing 7 contains a processing assembly; the assembly's input terminal connects to the signal output terminals from the IR sensor unit 1, and its output terminal connects to the microprocessor 3 input terminal. The processing assembly includes an amplifier module 8 and a filter module 9. The amplifier module output terminal connects to a filter module 9. The reason for this is that the signals produced by IR sensors receiving infrared rays are extremely weak and easily subject to outside interference. It is necessary to amplify these signals and filter them for noise, then filter out background light and finally send an effective trigger waveform.

Given the convenience of signal data communications and wireless communications links, there is a wireless communications unit 10 and USB communications port 11 installed at the microprocessor output terminal. In one non-limiting example the wireless communications unit 10 is a Bluetooth or another wireless data communications device that uses a different wireless communication protocol. Housing 7 has a waterproof coating on its outside to suit the humid environment of a kitchen and prevent that environment from affecting service life.

The apparatus may in one non-limiting example be used as follows. The user puts a hand close to sensing unit 1 and makes gestures. The person's body reflects the infrared rays sent out by the emitters back to the IR sensors; the infrared rays are received by the receivers, and then the receivers transform them into electrical signals. Then, the electrical signals are transmitted along to the signal processing unit that adjusts their waveform and transmits them to the microprocessor 3. When the microprocessor 3 receives a signal, it triggers an interrupt. The interrupts are processed through interrupt service routines that look up predetermined characters that correspond to certain gestures, and transmits the characters to the order server 4. Finally, the order server analyzes the characters to obtain relevant information that can be displayed on display 5, such as the name of the corresponding food item.

The microprocessor 3 transducer input level is normally low, but it is high when reflected IR radiation is sensed. After the additional processing by the processing assembly, this signal is transmitted to the microprocessor 3 as an interrupt trigger signal. The microprocessor 3 responds with an interrupt immediately after receiving the trigger signal, executing an interrupt service routine as depicted in FIG. 2. The main tasks of the interrupt service routine are to calculate the total number of sensor points and the particular sensors that received a signal and generated an output, and the timing in which the signals were received that the current gestures embody, and to record the properties of newly imported sensor signals. These properties include which sensor points detected the gestures, the sequence and quantity of the sensor points, and sensor signal input times.

A library of gestures can be established to facilitate unified operation. In practice, a code would be defined for each food item, making it possible to make inputs without physical contact with a data input device. Non limiting examples of the gestures include the following:
Select the first sensor 15 and slide up and right toward the second sensor 16 to indicate “1.”(a slide can be detected based on sequential sensing by two sensors within a predetermined time period)
Select the second sensor 16 and slide down and right toward the third sensor 17 to indicate “2.”
Select the third sensor 17 and slide down and left toward the fourth sensor 18 to indicate “3.”
Select the fourth sensor 18 and slide up and left toward the first sensor 15 to indicate “4.”
Select the second sensor 16 and slide down and left toward the first sensor 15 to indicate “5.”
Select the third sensor 17 and slide up and left toward the second sensor 16 to indicate “6.”
Select the fourth sensor 18 and slide up and right toward the third sensor 17 to indicate “7.”
Select the first sensor 15 and slide down and right toward the fourth sensor 18 to indicate “8.”
Select the first sensor 15 and slide right toward the third sensor 17 to indicate “9.”
Select the third sensor 17 and slide left toward the first sensor 15 to indicate “A.”
Select the second sensor 16 and slide down toward the fourth sensor 18 to indicate “B.”
Select the fourth sensor 18 and slide up toward the second sensor 16 to indicate “C.”

It is apparent that the above simply illustrate one scheme by which gestures comprising two sequential sensing can be interpreted as numbers and characters. But, other sensor actions and combinations (e.g., more than two sequential points) can be interpreted in other manners, as desired by the user.

In a library of preconfigured gestures, a correct sensor input should be two sensor points, so that end users can be near the sensors without triggering the gesture system. After the microprocessor collects the corresponding properties, it uses a set data structure to store the information. After the input of information from all sensors has been completed (which can be determined based on a time since the final sensor signal was received), the microprocessor uses a fixed algorithm to determine the relationship between the points, thereby identifying the specific gesture. To determine the actual meaning represented by the gesture, it is also necessary to find the character that corresponds to it in the pre-defined library of gestures. After the character is found, the microprocessor uses the USB port protocol or wireless protocol to transmit the character or other symbol to the order server that is part of an existing ordering system.

In addition, a simple lookup method can be used since the library of gestures is relatively small. An array representing the current input gestures is compared one by one with the database, and only when each sensor point and sequence number are in agreement can a gesture be considered a successful match.

It can be seen from the foregoing that, after this apparatus is adopted, orderers will be able to order different dishes or confirm dishes have been served by using input gestures. This is a result of data communication between the infrared sensing unit, processing unit, and order server. There is no keyboard used in this process, as it implements a non-contact method of data input and ensures food safety and health requirements are met. Moreover, the actual operation of the apparatus is simple and easy to learn, the overall construction is simple, and it is easily installed and used in restaurant kitchens.

These are only typical examples of technical solutions that implement this invention. Any equivalent technical solutions that are adopted or substituted fall within the scope of protection of this invention.

1. An infrared-based gesture ordering apparatus, comprising:
an infrared sensing unit comprising at least four infrared (IR) sensors, each with an independent infrared emitter and receiver, the sensing unit having an output;
a processing unit that receives the IR sensing unit outputs; and
a microprocessor that receives the processing unit output, where the microprocessor has an output that connects by USB or wireless to an order server that has a display device.

2. The apparatus of claim 1, wherein the four IR sensors are distributed more or less symmetrically in a vertical cross shape, with one sensor at 9 o'clock, a second at 12 o'clock, a third at 3 o'clock, and a fourth at 6 o'clock.

3. The apparatus of claim 1, further comprising protective tubing, wherein the IR sensors are shielded within the protective tubing.

4. The apparatus of wherein the processing unit comprises a processing assembly installed in a housing, wherein the processing assembly input receives the outputs from the IR sensors.

5. The apparatus of claim 4, wherein the processing assembly comprises an amplifier module and a filter module, where the output of the amplifier module connects to the filter module.

6. The apparatus of claim 4, wherein the housing has a waterproof coating on its outside.

7. The apparatus of claim 1, further comprising a wireless communications unit and USB (universal serial bus) communications port coupled to the output of the microprocessor.

8. The apparatus of claim 7, wherein the wireless communications unit is a Bluetooth or other wireless data communications device.

9. The apparatus of claim 1, wherein the display device is an LED (light emitting diode) or liquid crystal display.

10. A method of inputting food ordering information into an order server, comprising:
providing a gesture sensing device comprising a plurality of infrared (IR) sensors;
detecting a plurality of sequential sensings by the IR sensors;
interpreting the detected sensings as a gesture;
translating the gesture into a symbol or command; and
wirelessly or by USB transmitting the symbol or command to the order server.
